(19) United States
(12) Patent Application Publication
(10) Pub. No.: US 2020/0290185 A1
(43) Pub. Date: Sep. 17, 2020

(54) CONNECTING ROD ASSEMBLY FOR SCREWDRIVER BIT AND SLEEVE ASSEMBLY

(71) Applicant: Nanjing Chervon Industry Co., Ltd., Nanjing (CN)

(72) Inventor: Xiaofeng Zhang, Nanjing (CN)

(21) Appl. No.: 16/889,927

(22) Filed: Jun. 2, 2020

Related U.S. Application Data
(63) Continuation of application No. PCT/CN2019/079986, filed on Mar. 28, 2019.

(30) Foreign Application Priority Data
Apr. 16, 2018 (CN) 201820542835.3

(51) Int. Cl. B25B 23/00

(52) U.S. Cl. CPC B25B 23/0035; B25B 23/12

(57) ABSTRACT

A connecting rod assembly includes a connecting rod and a sleeve assembly movably connected to the connecting rod. The sleeve assembly includes a sleeve body, a functional body, and a locking member. The sleeve body extends along the central axis and is sleeved to one end of the connecting rod and is formed with a through hole through which at least part of a screwdriver bit passes. The functional body is connected to the sleeve body. The locking member is movably coupled to the sleeve body and has at least a locking position and an unlocking position relative to the sleeve body.

### RELATED APPLICATION INFORMATION

This application is a continuation of International Application Number PCT/CN2019/079986, filed on Mar. 28, 2019, through which this application also claims the benefit under 35 U.S.C. § 119(a) of Chinese Patent Application No. CN 201820542835.3, filed on Apr. 16, 2018, each of which is incorporated by reference in its entirety herein.

### TECHNICAL FIELD

The present disclosure relates to an accessory device, in particular, a connecting rod assembly for a screwdriver bit and a sleeve assembly.

### BACKGROUND

When a power tool is in service, a screwdriver bit is often fitted to a connecting rod for use, and some connecting rods are also fitted to a sleeve to form a connecting rod assembly. At present, frequently-used connecting rod assemblies with a magnetic nail-holding mechanism do not have a locking function for a screwdriver bit, thus the screwdriver bit is easily disengaged from the connecting rod assembly. In addition, most of the sleeves fitted with the connecting rods have non-detachable structures, which limit an application range of the connecting rod and the sleeve and cause waste when the connecting rod assembly is partially damaged.

### SUMMARY

In one described example, a connecting rod assembly for the screwdriver bit includes a connecting rod, one end of which is formed with a transmission slot capable of being fitted with the screwdriver bit, and another end of which is formed with a transmission shank for receiving power to rotate around a central axis. The connecting rod assembly further includes a sleeve assembly movably connected to the connecting rod. The sleeve assembly includes a sleeve body, a functional body, and a locking member; where the sleeve body extends along the central axis and is sleeved to an end of the connecting rod and is formed with a through hole through which at least part of the screwdriver bit passes; the functional body is connected to the sleeve body to realize a function of the sleeve assembly; the locking member is movably coupled to the sleeve body, and at least has a locking position and an unlocking position relative to the sleeve body. When the locking member is in the locking position, the sleeve assembly and the connecting rod form a non-detachable connection when the sleeve assembly is subjected to an axial force less than a first axial force; and when the locking member is in the unlocking position, the sleeve assembly and the connecting rod form a detachable connection when the sleeve assembly is subjected to an axial force greater than a second axial force, where the first axial force is greater than the second axial force.

In one described example, an end of the sleeve body is connected to or formed with an elastic portion capable of elastic deformation in a direction perpendicular to the central axis.

In one described example, in condition that the locking member is switched from the unlocking position toward the locking position, the elastic portion is configured to contract inward with the central axis as a center; and in condition that the locking member is switched from the locking position toward the unlocking position, the elastic portion is configured to expand outward with the central axis as the center.

In one described example, the sleeve body is further connected to or formed with a stopper configured for stopping the locking member from being disengaged from the sleeve body along the central axis.

In one described example, the connecting rod is formed with a stepped structure; and the elastic portion is formed with a stopper that is capable of cooperating with the step to prevent the sleeve assembly from being disengaged from the connecting rod along the central axis.

In one described example, the connecting rod is inserted into the sleeve body along a first direction parallel to the central axis, and the sleeve body is further connected to or formed with a limiting portion that prevents the connecting rod from continuing to move relative to the sleeve body along the first direction.

In one described example, the functional body at least includes a magnetic portion capable of attracting the screwdriver bit.

In one described example, the functional body is disposed at an end of the sleeve body opposite to the elastic portion.

In one described example, the sleeve body is further formed with an accommodation portion configured to accommodate at least part of the function body.

In one described example, the magnetic portion is symmetrically distributed about the central axis.

In one described example, part of the connecting rod is located inside the sleeve body; the connecting rod at least has a first position and a second position relative to the sleeve assembly along the central axis; in condition that the connecting rod is in the first position relative to the sleeve assembly, an end of the connecting rod is abutted against a limiting portion; in condition that the connecting rod is in the second position relative to the sleeve assembly, the connecting rod is disengaged from the limiting portion; and the magnetic portion is configured to generate a magnetic force capable of driving the connecting rod to move toward the first position.

In one described example, the screwdriver bit at least has a connection position and a disengagement position relative to the connecting rod; when at the connection position, the screwdriver bit is accommodated in the transmission slot and abuts against the connecting rod, and when at the disengagement position, the screwdriver bit is disengaged from the connecting rod; and the connecting rod is configured to generate a magnetic force capable of driving the screwdriver bit to move toward the connection position.

In one described example, the connecting rod is made of a magnetic material capable of attracting the screwdriver bit.

In one described example, the transmission slot is connected to or integrally formed with a magnetic material capable of attracting the screwdriver bit.

In one described example, the sleeve assembly is formed with a stopping portion configured for preventing the screwdriver bit from being disengaged from the connecting rod, and a distance from the stopping portion to the central axis is less than 3 mm.

In one described example, the sleeve body further includes a sliding groove located on an outer surface of the sleeve body, and the locking member is slidably disposed in the sliding groove.

In one described example, the sleeve body is made of a plastic material.

In one described example, the elastic portion is made of a plastic material.

In one described example, the elastic portion includes a plurality of claw portions extending along the central axis and symmetrically arranged about the central axis, and an end of a respective claw portion is fixedly connected to the sleeve body.

In one described example, a connecting rod assembly for the screwdriver bit includes a connecting rod, an end of which is formed with the transmission slot capable of being fitted with the screwdriver bit, and another end of which is formed with the transmission shank for receiving power to rotate around the central axis. The connecting rod assembly further includes a sleeve assembly movably connected to the connecting rod. The sleeve assembly includes the sleeve body, the functional body, and the locking member; where the sleeve body extends along the central axis and is sleeved to an end of the connecting rod and is formed with the through hole through which at least part of the screwdriver bit passes; the functional body is connected to the sleeve body; the locking member is connected to the sleeve body, and at least has a locked state and an unlocked state relative to the sleeve body. When the locking member is in the locked state relative to the sleeve body, the sleeve assembly is non-detachable relative to the connecting rod; and when the locking member is in the unlocked state relative to the sleeve body, the sleeve assembly is detachable relative to the connecting rod.

In one described example, a sleeve assembly adapted to a connecting rod includes a sleeve body, the functional body, and the locking member; where the sleeve body extends along the central axis and is sleeved to an end of the connecting rod and is formed with a through hole through which at least part of the screwdriver bit passes; the functional body is connected to the sleeve body to realize a function of the sleeve assembly; the locking member is movably coupled to the sleeve body, and at least has the locking position and the unlocking position relative to the sleeve body. When the locking member is in the locking position, the sleeve assembly and the connecting rod form the non-detachable connection when the sleeve assembly is subjected to an axial force less than the first axial force; and when the locking member is in the unlocking position, the sleeve assembly and the connecting rod form the detachable connection when the sleeve assembly is subjected to the axial force greater than the second axial force, where the first axial force is greater than the second axial force.

In one described example, a sleeve assembly adapted to the connecting rod includes a sleeve assembly, which extends along the central axis and is sleeved to an end of the connecting rod and is formed with the through hole through which at least part of the screwdriver bit passes; the functional body connected to the sleeve body to realize the function of the sleeve assembly; where the sleeve assembly further includes the locking member, connected to the sleeve body, and at least has the locked state and the unlocked state relative to the sleeve body. When the locking member is in the locked state relative to the sleeve body, the sleeve assembly is non-detachable from the connecting rod, and when the locking member is in the unlocked state relative to the sleeve body, the sleeve assembly is detachable relative to the connecting rod.

The present disclosure is beneficial in that the sleeve of the connecting rod assembly is detachable and the connecting rod assembly has a locking function for the screwdriver bit.

### BRIEF DESCRIPTION OF THE DRAWINGS

FIG. 1 is a plan view illustrating a connecting rod assembly according to a first example of the present disclosure in which a locking member is in an unlocked state;

FIG. 2 is a sectional view illustrating the connecting rod in FIG. 1 when inserted into a sleeve assembly;

FIG. 3 is a sectional view illustrating the connecting rod in FIG. 2 after inserted into the sleeve assembly;

FIG. 4 is an exploded view illustrating the connecting rod assembly in FIG. 1;

FIG. 5 is a sectional view illustrating a sleeve body of the connecting rod assembly in FIG. 1;

FIG. 6 is a schematic structural diagram illustrating the connecting rod assembly in FIG. 1 acting on a screwdriver bit in which the locking member is in a locked state; and

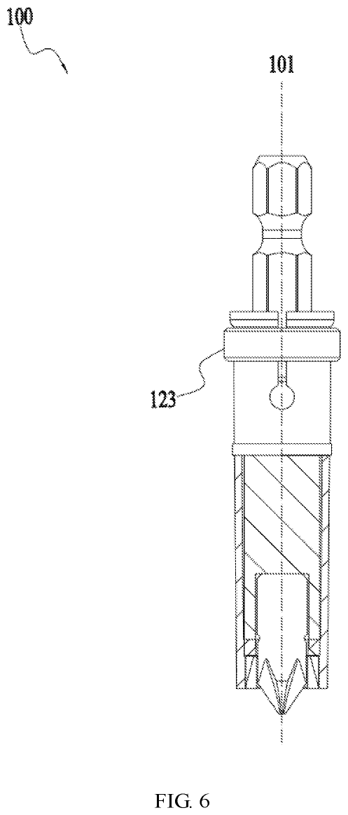

FIG. 7 is a plan view illustrating a connecting rod assembly according to a second example of the present disclosure in which a locking member is in the unlocked state.

### DETAILED DESCRIPTION

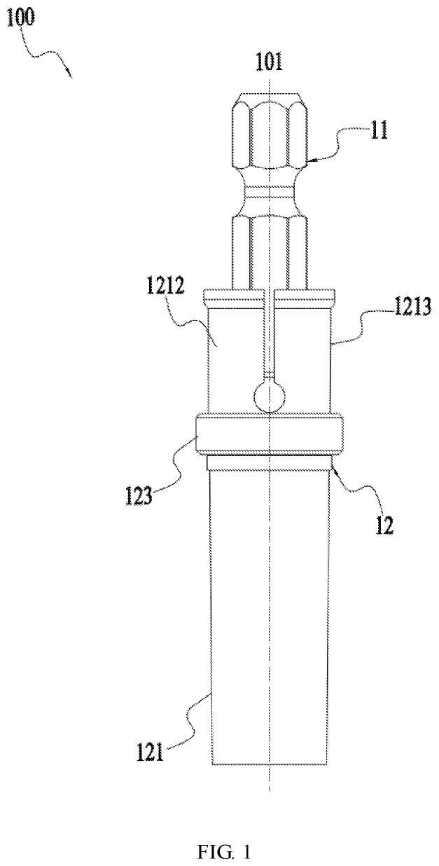

According to a first example as shown in FIG. 1, a connecting rod assembly 100 may include a connecting rod 11 and a sleeve assembly 12 capable of being sleeved onto the connecting rod 11. The sleeve assembly 12 may be adapted to different specifications or types of the connecting rod 11, after the sleeve assembly 12 is installed on the connecting rod 11, the entirety of the sleeve assembly 12 and the connecting rod 11 is adapted to the screwdriver bit, which may realize a nail-holding effect on the screw.

As shown in FIGS. 1 to 4, the sleeve assembly 12 is movably connected to the connecting rod 11. In one example, the sleeve assembly 12 is coaxially sleeved onto an end of the connecting rod 11 along a central axis 101. The connecting rod 11 is rotatable relative to the sleeve assembly 12 with the central axis 101 as an axis, and the connecting rod 11 is also slidable forward and backward along the central axis 101 relative to the sleeve assembly 12. An end of the connecting rod 11 is formed with a transmission groove 111 capable of being fitted with the screwdriver bit, and another end of the connecting rod 11 is formed with a transmission shank 112 that may be driven by a power tool to make the connecting rod 11 rotate about the central axis 101 as an axis. A sleeve assembly 12 includes a sleeve body 121, a functional body 122, and a locking member 123. The sleeve body 121 extends along a central axis 101 and is sleeved onto an end of the connecting rod 11 facing toward a transmission slot 111 and is formed with a through hole 1211 through which a screwdriver bit passes. The functional body 122 is fixedly connected to the sleeve body 121. The locking member 123 is coaxially and movably sleeved onto the sleeve body 121, and has a locking position and an unlocking position relative to the sleeve body 121. When the locking member 123 is in the locking position, the sleeve assembly 12 and the connecting rod 11 form a non-detachable connection when the sleeve assembly is subjected to an axial force less than a first axial force; and when the locking member is in the unlocking position, the sleeve assembly and the connecting rod form a detachable connection when the sleeve assembly is subjected to a axial force greater than a second axial force, where the first axial force is greater than the second axial force. That is, under normal operating conditions, when the locking member 123 is in the locking position relative to the sleeve body 121, the sleeve assembly 12 is not easily detached relative to the connecting rod 11, and when the locking member 123 is in the unlocking position relative to the sleeve body 121, the sleeve assembly 12 is easily detached from the connecting rod 11.

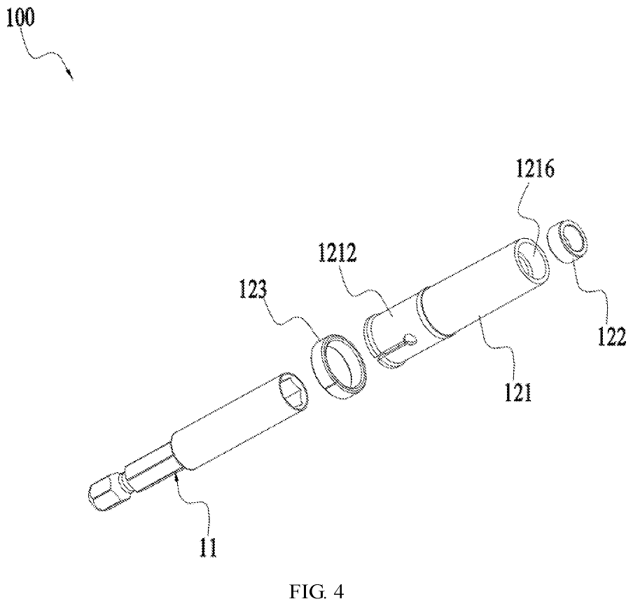

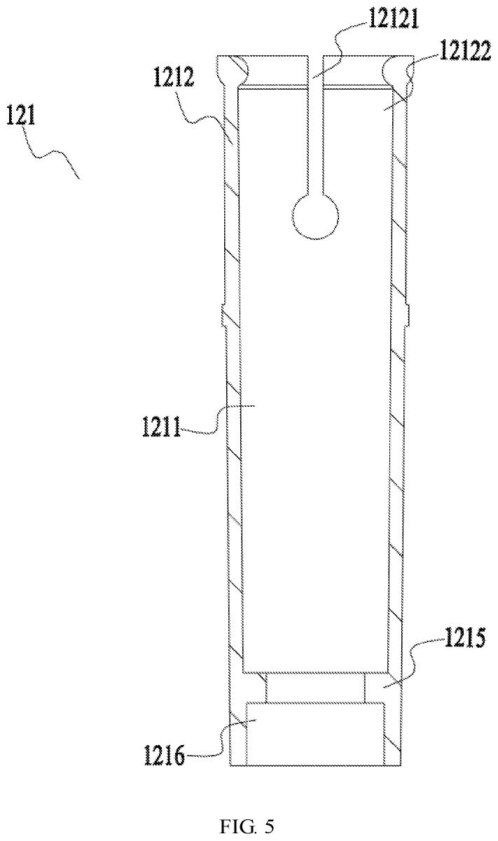

As shown in FIG. 5, the sleeve body 12 is made of plastic. An elastic portion 1212 capable of having elastic deformation in a direction perpendicular to the central axis 101 is connected or formed at an end of the sleeve body 121 facing toward the through hole 1211. In one example, the elastic portion 1212 is a part of the sleeve body 121, and the elastic portion 1212 may be integrally formed with the sleeve body 121 or may be fixedly or detachably connected to the sleeve body 121. The elastic portion 1212 includes an opening 12121 and a claw portion 12122. The opening 12121 and the claw portion 12122 are spaced apart along a circumferential direction of the sleeve body 121. A plurality of openings 12121 and a plurality of claw portions 12122 are symmetrical about the central axis 101 and are uniformly arranged in the circumferential direction of the sleeve body 121, respectively. The plurality of claw portions 12122 extend along the central axis 101 and are generally arc-shaped, and are fixedly connected to the sleeve body 121. The opening 12121 forms a hollow as shown in FIG. 4 on a surface of the sleeve body 121, and enables the elastic portion 1212 to have greater elastic deformation with the center axis 101 as a center. In one example, when the locking member 123, the screwdriver bit and the connecting rod 11 are inserted into the sleeve body 121, the elastic portion 1212 expands outward with the center axis 101 as the center. When the locking member 123 switches from the locking position to the unlocking position, the elastic portion 1212 shrinks inward with the center axis 101 as the center, that is, after the screwdriver bit and the connecting rod 11 are inserted into the sleeve body 121, the locking member 123 is in the locking position, and the elastic portion 1212 shrinks inward with the center axis 101 as the center. Therefore, a relative position of the connecting rod 11 and the sleeve body 121 is locked by interaction of the elastic portion 1212 and the connecting rod 11, thereby locking a position of the screwdriver bit.

In one example, the elastic portion 1212 is made of plastic.

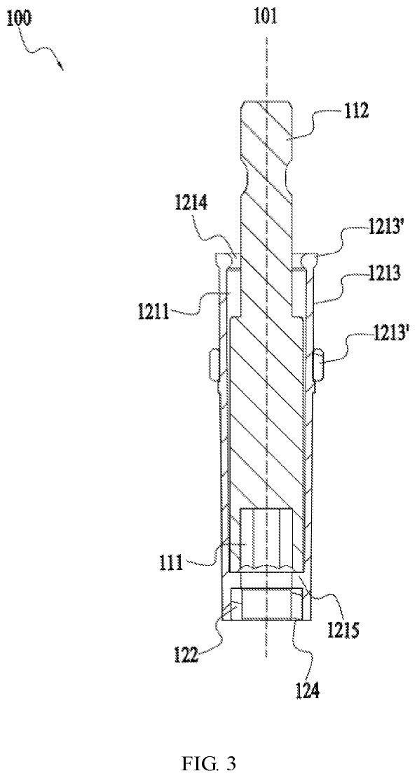

As shown in FIGS. 1 and 3, the sleeve body 121 is further connected to or formed with a stopper 1213′ for stopping the locking member 123 from disengaging from the sleeve body 121 along the central axis 101, and the stopper 1213′ circumferentially surrounds the sleeve body 121 and radially protrudes outward from the sleeve body 121 to form a convex edge. Two stoppers 1213′ are spaced up and down from each other along the central axis 101 at a certain distance to form a sliding groove 1213. The sliding groove 1213 is located on an outer surface of the sleeve body 121, the locking member 123 is slidably disposed in the sliding groove 1213, and is slidable relative to the sleeve body 121 in the sliding groove 1213 along the central axis 101 to the locking position, the unlocking position, and any position between the locking position and the unlocking position.

In one example, the connecting rod 11 is an inactive connecting rod. An end of the connecting rod 11 facing toward the transmission groove 111 and an end of the connecting rod 11 facing toward the transmission shank 112 are fixedly connected, and the connecting rod 11 is formed with a stepped structure. The elastic portion 1212 is formed with a stopper 1214 that is fitted with the stepped structure to prevent the sleeve assembly 12 from disengaging from the connecting rod 11 along the central axis 101. In one example, after the screwdriver bit and the connecting rod 11 are inserted into the sleeve body 121, the locking member 123 slides to the locking position along the central axis 101 while the elastic portion 1212 contracts inward with the central axis 101 as the center; under the action of the locking member 123, the stopper 1214 abuts against a surface of the connecting rod 11; and when the connecting rod 11 is subject to a force in a direction opposite to a first direction A or the sleeve body 121 is subject to a force parallel to the first direction A, the connecting rod 11 moves relative to the sleeve body 121 along the direction of the force. During this process, the stopper 1214 is clamped to the stepped structure of the connecting rod 11, thereby preventing the sleeve assembly 12 from disengaging from the connecting rod 11 along the central axis 101.

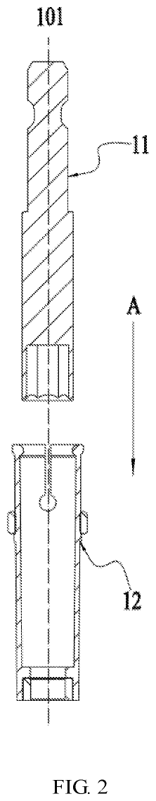

As shown in FIGS. 2 to 4, the connecting rod 11 is inserted into the sleeve body 121 along the first direction A parallel to the central axis 101. The sleeve body 121 is also connected to or formed with a limiting portion 1215 that prevents the connecting rod 11 from continuing to move along the first direction A relative to the sleeve body 121, that is, during a process of the connecting rod 11 being inserted into the sleeve body 121 along the first direction A parallel to the central axis 101, the connecting rod 11 is blocked by the limiting portion 1215, thereby abutting against the limiting portion 1215. In one example, the limiting portion 1215 is an annular body arranged inside the sleeve body 121, the annular body is coaxial with and integrated with the sleeve body 121, and an inner diameter of the annular body is less than an outer diameter of the connecting rod 11, so as to prevent the connecting rod 11 from disengaging from the sleeve body 121 along the first direction A.

As shown in FIGS. 4 and 5, the functional body 122 at least includes a magnetic portion capable of attracting the screwdriver bit. In the present example, the functional body 122 includes a magnet, such as a ring magnet, capable of attracting the screwdriver bit. An end of the sleeve body 121 facing away from the elastic portion 1212 is further formed with an accommodation portion 1216 for accommodating the functional body 122, that is, the functional body 122 is located at an end of the sleeve main body 121 and the elastic portion 1212 is located at another end of the sleeve main body 121. The functional body 122 is embedded in the accommodation portion 1216, and is coaxially and fixedly connected to the sleeve body 121, and an end surface of the functional body 122 and an end surface of the sleeve body 121 are on a same plane. Certainly, a connection form of the functional body 122 and the accommodation portion 1216 is not limited to a fixed connection, and is not limited to the above-mentioned mosaic structure. When the screwdriver bit is mounted to the connecting rod assembly 100 and is in a working state, the functional body 122 may attract the screw so that the screw does not shake or disengage relative to the screwdriver bit, so as to realize the nail-holding effect, enabling an operator to complete work with only one hand, without holding the screw with one hand and operating the connecting rod 11 with another hand. It can be understood that the structural form of the magnetic portion is not limited to the single integral circular ring magnet structure in the present example, but may also be other integral or split structures that are symmetrical relative to the central axis.

Part of the connecting rod 11 is located inside the sleeve body 121, and the connecting rod 11 at least has a first position and a second position relative to the sleeve assembly 12 along the central axis 101. When the connecting rod 11 is in the first position relative to the sleeve assembly 12, an end of the connecting rod 11 abuts against the limiting portion 1215; and when the connecting rod 11 is in the second position relative to the sleeve assembly 12, the connecting rod 11 is disengaged from the limiting portion 1215. And the magnetic portion generates a magnetic force that may drive the connecting rod 11 to move toward the first position. That is to say, the functional body 122 generates the magnetic force that drives the connecting rod 11 to move toward the first position; when there is no external axial force along the central axis 101, the connecting rod 11 keeps in the first position relative to the sleeve assembly 12, that is, an end of the connecting rod 11 facing toward the transmission groove 111 is in contact with the limiting portion 1215 and is maintained at the contact position; when the connecting rod 11 is subjected to an external force that is greater than the second axial force and less than the first axial force and is opposite to the first direction A, the connecting rod 11 is disengaged from the limiting portion 1215. If the locking member 123 is in the unlocking position, the connecting rod 11 may be disengaged from the sleeve assembly 12 under the external force; and if the locking member 123 is in the locking position, the connecting rod 11 moves farthest to the second position relative to the sleeve assembly 12 under the action of the external force but cannot be disengaged from the sleeve assembly 12. Certainly, the connecting rod 11 may move relative to the sleeve assembly 12 to any position between the first position and the second position under the external force.

In one example, the screwdriver bit at least has a connection position and a disengagement position relative to the connecting rod 11. When the screwdriver bit is in the connection position, the screwdriver bit is accommodated in the transmission slot 111 and abuts against the connecting rod 11; and when the screwdriver bit is in the disengagement position, the screwdriver bit is disengaged from the connecting rod 11. The connecting rod 11 generates the magnetic force that may drive the screwdriver bit to move toward the connection position, that is to say, the connecting rod 11 is made of a magnetic material capable of attracting the screwdriver bit, so that the connecting rod 11 always has a magnetic attraction to the screwdriver bit, so that the screwdriver bit may be tightly mounted to the connecting rod 11. Certainly, the screwdriver bit may overcome the magnetic attraction to move to the disengagement position under the action of external force. In one example, part of the connecting rod 11 is made of the magnetic material. For example, the transmission groove 111 is connected to or integrally formed with the magnetic material capable of attracting the screwdriver bit. As shown in FIGS. 1 to 3, the sleeve assembly 12 is formed with a stopping portion 124 for preventing the screwdriver bit from disengaging from the connecting rod 11, and a distance between the stopping portion 124 and the central axis 101 is less than 3 mm. For commonly used screwdriver bit with a diameter ranges from 6 mm to 7 mm, when the connecting rod assembly 100 is used to cooperate with the commonly used screwdriver bit, the stopping portion 124 limits the screwdriver bit in the first direction A so that only part of the screwdriver bit may pass a screwdriver bit hole 124, preventing the screwdriver bit from disengaging from the connecting rod 11 and the sleeve assembly 12 from the first direction A. In the locking position, the locking member 123 prevents the screwdriver bit from disengaging from the connecting rod 11 and the sleeve assembly 12 from the direction opposite to the first direction A, thereby realizing the function of locking the screwdriver bit.

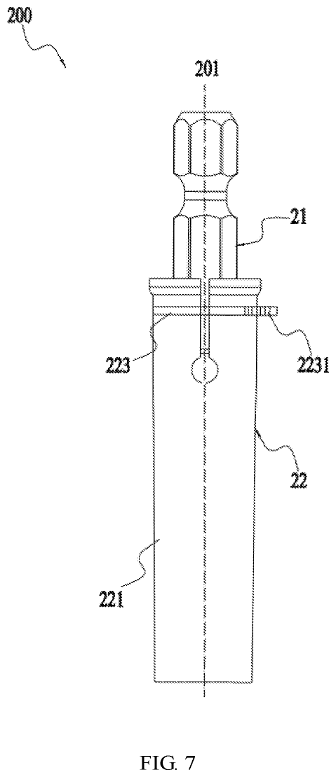

FIG. 7 illustrates a connecting rod assembly 200 according to a second example. In the present example, the connecting rod assembly 200 may have a connecting rod 21 having the same structure as that of the second example, except that the structures of the locking member 223 and the sleeve body 221 of the sleeve assembly 22 in the present example are different. The portions of the first example that are compatible with the present example may be applied to the present example. Only the differences between the present example and the first example will be described below.

In the present example, the sleeve assembly 22 includes the sleeve body 221, the magnetic portion (not shown in the figure), and a locking sleeve 223; where the locking sleeve 223 is fixedly connected to the sleeve body 221, and the locking sleeve 223 includes an adjusting portion 2231 that may extend relative to the sleeve body 221 in a plane perpendicular to the central axis 201 so as to adjust the tightness of the connection between the locking sleeve 223 and the sleeve body 221. The locking sleeve 223 has the locked state and the unlocked state relative to the sleeve body 221. When the locking sleeve 223 is in the locked state relative to the sleeve body 221, the locking sleeve 223 makes the elastic portion 2212 shrink inwardly with the central axis 201 as the center via the adjusting portion 2231, thereby locking the sleeve body 221 and the connecting rod 21 so that the sleeve assembly 22 is non-detachable relative to the connecting rod 21; and when the locking sleeve 223 is in the unlocked state relative to the sleeve body 221, the sleeve assembly 22 is detachable relative to the connecting rod 21. It can be understood that the connection manner between the locking sleeve 223 and the sleeve body 221 may also be a movable connection manner. In addition, since the locking sleeve 223 is fixedly connected to the sleeve body 221 in the present example, the sleeve body 221 does not include the sliding groove 1213 and the similar movable connection structure in the first example, but it can be understood that in the present example, the locking sleeve 223 and the sleeve body 221 may also form a movable connection, and the sleeve body 221 may also form a limit structure for the locking sleeve 223.

In fact, it can be understood that, in other examples, the locking member may also be other structural members having the locking function, and the connection manner between the sleeve body and the locking member is also not limited to the preferred modes in the above-mentioned two examples.

The above illustrates and describes basic principles, main features and advantages of the present disclosure. It is to be understood by those skilled in the art that the above examples do not limit the present disclosure in any form, and all solutions obtained by means of equivalent substitution or equivalent transformation fall within the protection scope of the present disclosure.

What is claimed is:

1. A connecting rod assembly for a screwdriver bit, comprising:
a connecting rod, wherein one end of the connecting rod is formed with a transmission slot capable of being fitted with the screwdriver bit and another end of the connecting rod is formed with a transmission shank configured for receiving power to rotate around a central axis; and
a sleeve assembly movably connected to the connecting rod;
wherein the sleeve assembly comprises:
a sleeve body extending along the central axis, wherein the sleeve body is sleeved to the one end of the connecting rod and forms a through hole through which at least part of the screwdriver bit passes;
a functional body connected to the sleeve body to realize a function of the sleeve assembly; and
a locking member movably connected to the sleeve body;
wherein the locking member at least has a locking position and an unlocking position relative to the sleeve body;
wherein, in condition that the locking member is in the locking position, the sleeve assembly and the connecting rod form a non-detachable connection when the sleeve assembly is subjected to an axial force that is less than a first axial force;
wherein, in condition that the locking member is in the unlocking position, the sleeve assembly and the connecting rod form a detachable connection when the sleeve assembly is subjected to another axial force that is greater than a second axial force; and
wherein the first axial force is greater than the second axial force.

2. The connecting rod assembly according to claim 1, wherein an end of the sleeve body is connected to or formed with an elastic portion capable of elastically deforming in a direction perpendicular to the central axis.

3. The connecting rod assembly according to claim 2, wherein, in condition that the locking member is switched from the unlocking position toward the locking position, the elastic portion is configured to contract inward with the central axis as a center; and, in condition that the locking member is switched from the locking position toward the unlocking position, the elastic portion is configured to expand outward with the central axis as a center.

4. The connecting rod assembly according to claim 1, wherein the sleeve body is further connected to or formed with a stopper configured for stopping the locking member from being disengaged from the sleeve body along the central axis.

5. The connecting rod assembly according to claim 2, wherein the connecting rod is formed with a stepped structure and the elastic portion is formed with a stopper that is capable of cooperating with the stepped structure to prevent the sleeve assembly from being disengaged from the connecting rod along the central axis.

6. The connecting rod assembly according to claim 1, wherein the connecting rod is inserted into the sleeve body along a first direction parallel to the central axis and the sleeve body is further connected to or formed with a limiting portion that prevents the connecting rod from continuing to move relative to the sleeve body along the first direction.

7. The connecting rod assembly according to claim 6, wherein the functional body at least comprises a magnetic portion capable of attracting the screwdriver bit.

8. The connecting rod assembly according to claim 7, wherein the functional body is disposed at an end of the sleeve body opposite to the elastic portion.

9. The connecting rod assembly according to claim 8, wherein the magnetic portion is symmetrically distributed about the central axis.

10. The connecting rod assembly according to claim 9, wherein a part of the connecting rod is located inside the sleeve body, the connecting rod at least has a first position and a second position relative to the sleeve assembly along the central axis, in condition that the connecting rod is in the first position relative to the sleeve assembly, an end of the connecting rod is abutted against the limiting portion, in condition that the connecting rod is in the second position relative to the sleeve assembly, the connecting rod is disengaged from the limiting portion, and the magnetic portion is configured to generate a magnetic force capable of driving the connecting rod to move toward the first position.

11. The connecting rod assembly according to claim 1, wherein the screwdriver bit at least has a connection position and a disengagement position relative to the connecting rod, in condition that the screwdriver bit is in the connection position, the screwdriver bit is accommodated in the transmission slot and abutted against the connecting rod, in condition that the screwdriver bit is in the disengagement position, the screwdriver bit is disengaged from the connecting rod, and the connecting rod is configured to generate a magnetic force capable of driving the screwdriver bit to move toward the connection position.

12. The connecting rod assembly according to claim 1, wherein the connecting rod is made of a magnetic material capable of attracting the screwdriver bit.

13. The connecting rod assembly according to claim 1, wherein the transmission slot is connected to or integrally formed with a magnetic material capable of attracting the screwdriver bit.

14. The connecting rod assembly according to claim 1, wherein the sleeve assembly is formed with a stopping portion configured for preventing the screwdriver bit from being disengaged from the connecting rod, and a distance from the stopping portion to the central axis is less than 3 mm.

15. The connecting rod assembly according to claim 1, wherein the sleeve body further comprises a sliding groove located on an outer surface of the sleeve body and the locking member is slidably disposed in the sliding groove.

16. The connecting rod assembly according to claim 1, wherein the sleeve body is made of a plastic material.

17. The connecting rod assembly according to claim 2, wherein the elastic portion is made of a plastic material.

18. The connecting rod assembly according to claim 2, wherein the elastic portion comprises a plurality of claw portions extending along the central axis and symmetrically arranged about the central axis and an end of a respective claw portion is fixedly connected to the sleeve body.

19. A connecting rod assembly for a screwdriver bit, comprising:
a connecting rod, wherein one end of the connecting rod is formed with a transmission slot capable of being fitted with the screwdriver bit and another end of the connecting rod is formed with a transmission shank configured for receiving power to rotate around a central axis; and
a sleeve assembly movably connected to the connecting rod;
wherein the sleeve assembly comprises:
a sleeve body extending along the central axis, wherein the sleeve body is sleeved to the one end of the connecting rod and forms a through hole through which at least part of the screwdriver bit passes;
a functional body connected to the sleeve body; and
a locking member connected to the sleeve body;
wherein the locking member at least has a locked state and an unlocked state relative to the sleeve body;
wherein, in condition that the locking member is in the locked state relative to the sleeve body, the sleeve assembly is non-detachable relative to the connecting rod, and
wherein, in condition that the locking member is in the unlocked state relative to the sleeve body, the sleeve assembly is detachable relative to the connecting rod.

20. A sleeve assembly, comprising:
a sleeve body extending along a central axis, wherein the sleeve body comprises an elastic portion disposed at a first end of the sleeve body and the sleeve body forms a through hole for a part of a screwdriver bit to pass through;
a functional body connected to a second end of the sleeve body to realize a function of the sleeve assembly;
a locking member movably connected to the sleeve body;
wherein the locking member at least has a locking position and an unlocking position relative to the sleeve body;
wherein, in condition that the locking member is in the locking position, the elastic portion is configured to contract inward with the central axis as a center;
wherein, in condition that the locking member is in the unlocking position, the elastic portion is configured to expand outward with the central axis as a center.
